(19) United States
(12) Patent Application Publication
(10) Pub. No.: US 2006/0113777 A1
(43) Pub. Date: Jun. 1, 2006

(54) Passenger airbag system

(76) Inventors: Michael Dancasius, Wuppertal (DE); Achim V. Der Muehlen, Wuppertal (DE); Stephen Pitrof, Bellbrook, OH (US)

Correspondence Address: JAMES C. LYDON, 100 DAINGERFIELD ROAD, SUITE 100, ALEXANDRIA, VA, 22314, US

(21) Appl. No.: 10/999,026

(22) Filed: Nov. 30, 2004

(51) Int. Cl. B60R 21/16

(52) U.S. Cl. 280/732; 280/728.2

(57) ABSTRACT

An airbag system including an airbag housing, for containing an airbag, a chute channel for guiding the airbag towards a passenger cabin upon inflation and an instrument panel (IP), separating the airbag housing and the chute channel from the passenger cabin where the chute channel is adapted to be deformed in case of impact on the IP, in order to absorb head impact energy exerted on the IP.

The present invention relates to an airbag system comprising an airbag housing for containing an airbag, a chute channel for guiding the airbag towards a passenger cabin upon inflation and an instrument panel, separating the airbag housing and the chute channel from the passenger cabin.

An airbag system according to the introduction is known from the prior art. The airbag is positioned inside a relatively rigid airbag housing. In case of a crash of a car, the airbag will deflate and will be guided by means of the chute channel through the instrument panel towards the passenger cabin. The deflated airbag will protect the passenger and will absorb the energy of the passenger traveling towards the instrument panel and will thereby decelerate the body parts of the passenger in a controlled manner.

In order to inflate the airbag, a car provided with an airbag system, should crash with a certain minimum velocity. It is possible that a car crashes, without the airbag being inflated. Because of inertia, in that case, the passenger will move towards the instrument panel. Upon impact of the head on the instrument panel, the presence of the relatively rigid airbag housing is a risk for the safety of the passenger. The rigid airbag housing is not able to absorb energy and is thereby not able to decelerate the head in a controlled manner. In the prior art, solutions are known to increase the safety of the passenger by increasing the distance between the head impact service on the instrument panel of a car and the structure of the rigid airbag system and the rigid car part such as the cross-car-beam, carrying the rigid airbag system.

The increased safety will demand an increased package effort in order to minimize the dimensions of the airbag system. Alternatively, the created space can be filled with additional, costly, crash energy absorbing elements.

With respects to the above, an object of the present invention is to provide increased passenger's safety in a cost effective manner.

This object, according to the present invention is achieved in that the invention provides an airbag system comprising an airbag housing, for containing an airbag, a chute channel for guiding the airbag towards a passenger cabin upon inflation and an instrument panel (IP), separating the airbag housing and the chute channel from the passenger cabin wherein the chute channel is adapted to be deformed in case of impact on the IP, in order to thereby absorb head impact energy exerted on the IP.

According to the invention, it is possible that the chute channel is positioned at an angular position with respect to the airbag housing, in order to allow the chute channel to deform angular and lateral and simultaneously to slide along the airbag housing upon impact on the IP.

Because of these measures, the chute channel, which is present, anyway, is used to absorb an important part of the head impact energy upon impact over the head on the instrument panel.

For the design the chute channel is integrated part of the Instrument Panel System, the chute channel wall is positioned at an angular position with respect to the airbag housing, in order to allow the chute channel wall to deform angular and lateral and simultaneously to slide along the airbag housing upon impact on the IP.

For a further solution whereby the chute channel and the airbag housing are designed both as integrated parts of the Instrument Panel System the chute channel wall will be positioned at an angular position with respect to the airbag housing, in order to allow the chute channel wall to deform and to slide along the airbag housing upon impact on the IP.

In order to further improve the system according to the present invention, the chute channel is provided with ribs to reinforce the chute channel and to tune the deformation resistance upon impact on the IP.

The presence of these ribs will allow a fine tuning of the deformation of the chute channel in order to provide a maximum deceleration of the head, without exceeding deceleration levels which might endanger the safety of the passenger.

In order to further improve the capability of the airbag system to absorb head impact energy, the airbag housing is connected to the instrument panel, by means of deformable elements, to absorb energy exerted on the instrument panel.

According to the invention, it is possible that these deformable elements comprise deformable brackets. Alternatively, the deformable elements comprise plastic material, such as rubber.

By connecting the airbag housing to the instrument panel by means of deformable elements, a further element is provided to absorb head impact energy.

In order to further improve the system, the airbag housing is connected to a rigid car part, such as the cross-car-beam (ccb), by means of deformable elements, to absorb energy in case of displacement of the airbag housing towards the rigid car part.

The deformable elements may have the form of deformable brackets. Alternatively, the deformable elements may comprise a plastic material, such as rubber.

According to the invention, it is possible that an energy absorbing element is provided in between the rigid car part and the airbag housing to absorb energy in case of displacement of the airbag housing towards the rigid car part.

By means of the measures as described above, it is possible to fine tune the movement of the instrument panel towards the airbag housing and the airbag housing towards a rigid car part such as car-cross-beam, and to thereby control the deceleration of a passenger without exceeding maximum admitted values thereof.

The system according to the present invention provides a cost effective system which does not need costly additional energy absorbing elements. The energy absorbing features are integrated in the already existing parts. The system according to the present invention requires limited space which allows package flexibility.

The present invention is described wherein reference is made to the drawings wherein:

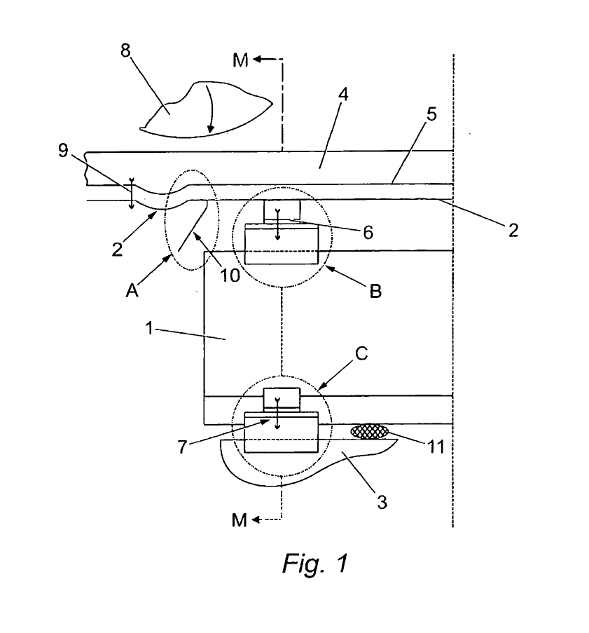

FIG. 1 provides an overview of the airbag system according to the present invention;

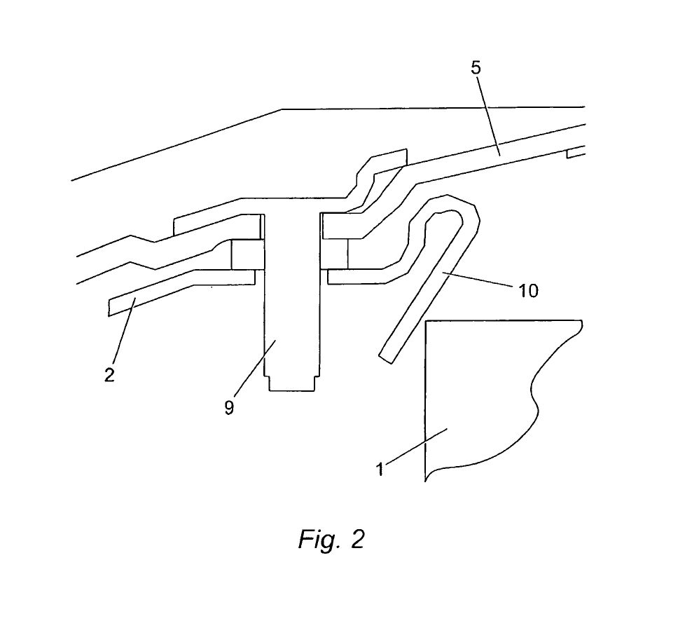

FIG. 2 shows in details the attachment of the chute channel to the instrument panel;

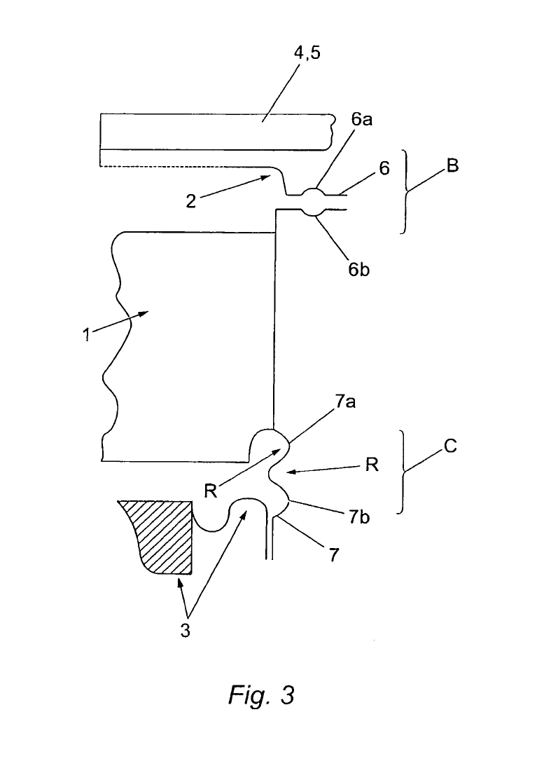

FIG. 3 shows a possible embodiment for the deformation elements between the airbag housing and the instrument panel and the cross-car-beam, respectively;

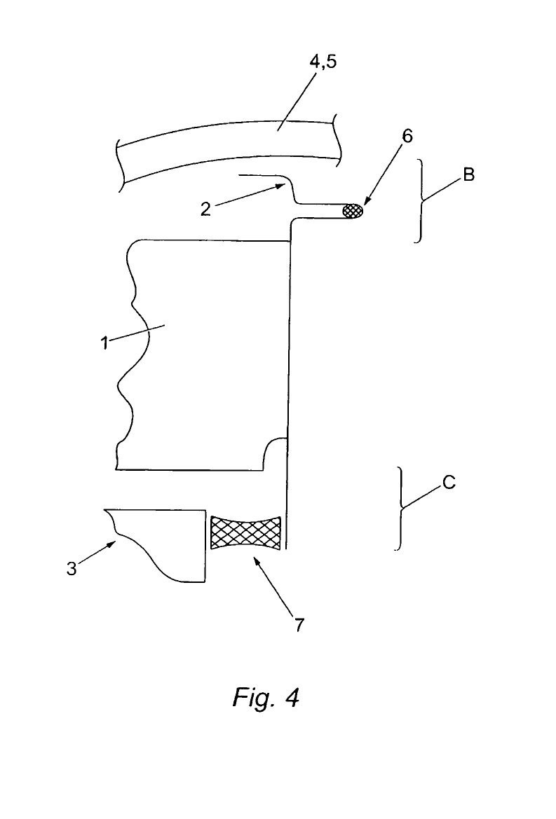

FIG. 4 shows an alternative embodiment of the airbag housing attachment according to FIG. 3.

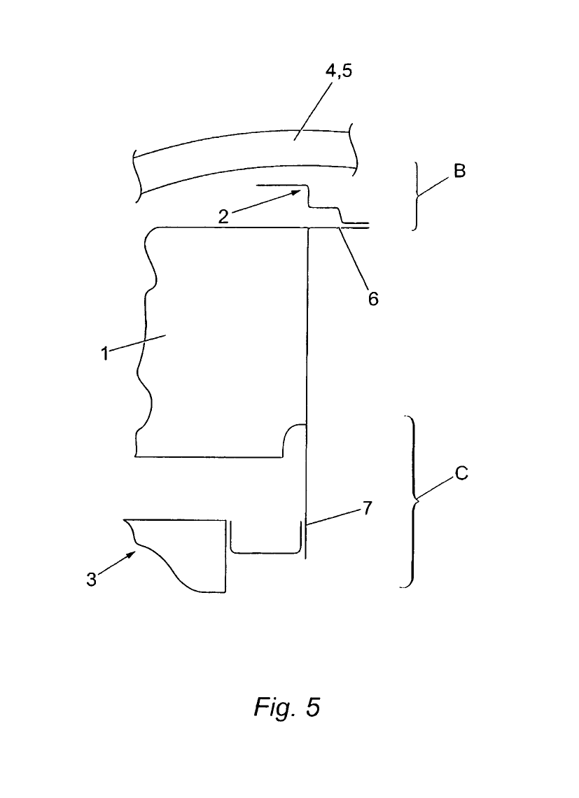

FIG. 5 shows a further alternative for the airbag housing attachment according to FIG. 3.

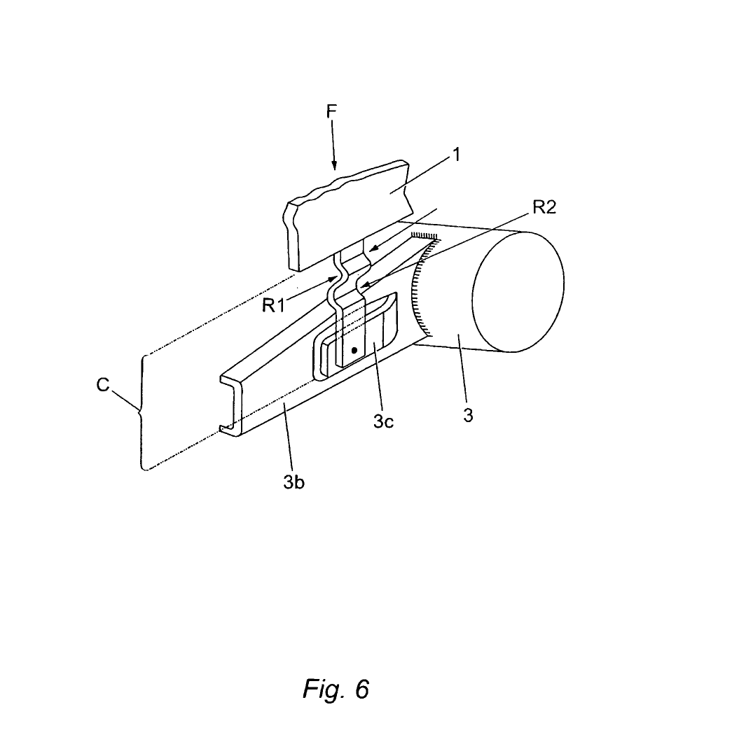

FIG. 6 shows a perspective view of the airbag housing to the cross-car-beam.

FIG. 1 shows an airbag system according to the present invention. The airbag system comprises an airbag housing 1, containing an airbag. In order to guide the airbag upon inflation, an airbag chute channel 2 is provided; this airbag chute channel is provided with a deformation energy absorbing wall 10. The chute channel 3 is connected to the IP carrier 5. The IP carrier 5 contains the IP foam 4. The airbag housing 1 is connected to a rigid car part, being the cross-car-beam 3.

The airbag housing 1 is connected to the IP 4, 5 by means of an attachment 6. The airbag housing 1 is connected to the cross-car-beam 3 by means of a second attachment 7.

The chute channel 2 is connected to the IP carrier 5 by means of an attachment 9.

As shown in FIG. 1, in between the housing 1 and the cross-car-beam 3, the flexible material in the form of a rubber bracket 11 is present.

The chute channel 2 having a deformation energy absorbing wall 10 will provide a first deformation zone A. The first attachment 6 provides a second deformation zone B, the second attachment 7 provides a third deformation zone C.

In FIG. 1, a head impact is systematically indicated by means of a head 8. In case the head 8 will impact on the IP 4, 5, the following will happen:

The impact force exerted by the head 8 on the IP 4, 5 will be absorbed by the deformable element 6 in the deformation zone B. The deformation of the element 6 will absorb a first part of the head impact energy. After deformation, the IP 4, 5, the first attachment 6 and the airbag housing 1 will together travel forward and thereby deform the second attachment 7 in the deformation zone C. The deformation of the second attachment 7 will absorb a second amount of head impact energy. After deformation of the deformation element 7 the instrument panel 4, 5, will continue to move downwards, wherein the deformation energy absorbing wall 10 of the chute channel will slide along the airbag housing 1 and will thereby deform and absorb the main amount of head impact energy.

The wall 10 is designed in order to define an angular relative to the airbag housing 1 and can be reinforced by means of ribs, in order to provide a sufficient deformation resistance. The shape of the wall 10 permits the chute channel to slide along the airbag housing. The chute channel 2 does not lie on the airbag can. It is designed to get tangent to the airbag can during the head impact.

In FIG. 2, in detail, the connection of the chute channel 2 and the deformation energy absorbing wall 10 to the IP carrier 5 is shown.

The chute channel 2 is connected to the IP carrier 5 by means of a bracket 9.

FIG. 3 shows a first possible embodiment of the first attachment 6 in the deformation zone B. The first attachment according to FIG. 3 contains deformable brackets. The deformation resistance can be tuned by adding ribs 6a, 6b and by altering the length B of the brackets.

FIG. 3 also shows a first embodiment of the second attachment 7. The second attachment 7 according to FIG. 3 is formed of brackets. The resistance against deformation of the brackets can be tuned by adding ribs 7a, 7b to the second attachment.

FIG. 4 shows a second embodiment of the first attachment 6 and the second attachment 7 in deformation zones B and C. According to FIG. 4, the attachments comprise a plastic material such as rubber.

FIG. 5 shows a further embodiment of the first attachment 6 and the second attachment 7 in the first deformation zone B and the second deformation zone C, respectively.

FIG. 6 shows in perspective a possible embodiment of the second attachment 7 for connecting the airbag housing 1 to the cross-car-beam 3.

FIG. 6 shows that the cross-car-beam 3 is provided with a cross-car-beam bracket 3b. To the cross-car-beam 3b an integrated deformation arm 3c is connected. The integrated deformation arm 3c is forced out of the material of the cross-car-beam bracket 3b. The airbag attachment 7 is attached to this integrated deformation arm 3c in order to support the airbag housing 1. The bracket 7 is provided with a first and a second rib having a radius of R1 and R2 respectively.

1. An airbag system comprising an airbag housing, for containing an airbag, a chute channel for guiding the airbag towards a passenger cabin upon inflation and an instrument panel (IP), separating the airbag housing and the chute channel from the passenger cabin wherein the chute channel is adapted to be deformed in case of impact on the IP, in order to thereby absorb head impact energy exerted on the IP.

2. An airbag system according to claim 1, wherein the chute channel side wall is positioned at an angular position with respect to the airbag housing, in order to allow the chute channel wall to deform angular and lateral and simultaneously to slide along the airbag housing upon impact on the IP.

3. An airbag system according to claim 1, wherein the chute channel is integrated part of the Instrument Channel System, and the chute channel wall is positioned at an angular position with respect to the airbag housing, in order to allow the chute channel wall to deform angular and lateral and simultaneously to slide along the airbag housing upon impact on the IP.

4. An airbag system according to claim 1, wherein the chute channel and the airbag housing are build as integrated parts of the Instrument Panel System and the chute channel side wall is positioned at an angular position with respect to the airbag housing, in order to allow the chute channel wall to deform angular and lateral and simultaneously to slide along the airbag housing upon impact on the IP.

5. An airbag system according to claim 4, wherein the deformable elements have the form of deformable brackets.

6. An airbag system according to claim 4, wherein the deformable elements comprise a plastic material for absorbing energy.

7. An airbag system according to claim 1, wherein the airbag housing is connected to a rigid car part, by means of deformable elements, to absorb energy in case of displacement of the airbag housing towards the rigid car part.

8. An airbag system according to claim 7, wherein the deformable elements have the form of deformable brackets.

9. An airbag system according to claim 7, wherein the deformable elements comprise a plastic material.

10. An airbag system according to claim 1, wherein an energy absorbing element is provided in between the rigid car part and the airbag housing to absorb energy in case of displacement of the airbag housing towards the rigid car part.

11. An airbag system according to claim 6, wherein said plastic material is a rubber.

12. An airbag system according to claim 7, wherein said rigid car part comprises a cross-car-beam.

13. An airbag system according to claim 9, wherein said plastic material is a rubber.
